(19) United States
(12) Patent Application Publication
(10) Pub. No.: US 2011/0278325 A1
(43) Pub. Date: Nov. 17, 2011

(54) FLUID DELIVERY SYSTEM

(76) Inventors: Chuan Hui FANG, Hong Kong (CN); Yue Li, Hong Kong (CN)

(21) Appl. No.: 13/102,141

(22) Filed: May 6, 2011

(30) Foreign Application Priority Data
May 11, 2010 (CN) 201010174448.7

(51) Int. Cl. B67D 7/78; B67D 7/80

(52) U.S. Cl. 222/145.5; 222/146.1

(57) ABSTRACT

A fluid delivery system includes a mixing chamber for mixing liquid and substances therein. The mixing chamber has an outlet and several inlets for entering of the liquid and substances. A pump is connected to one of the inlets and outlet for urging the liquid to enter into the mixing chamber via one of the inlets and to exit the mixing chamber via the outlet. A heating/cooling device is connected to or formed as a part of the mixing chamber and arranged to heat/cool the liquid and substances contained in the mixing chamber.

### CROSS REFERENCE TO RELATED APPLICATIONS

This non-provisional patent application claims priority under 35 U.S.C. §119(a) from Patent Application No. 201010174448.7 filed in The People's Republic of China on May 11, 2010.

### FIELD OF THE INVENTION

The invention relates to a fluid delivery system, and in particular to a fluid delivery system with a compact structure.

### BACKGROUND OF THE INVENTION

FIG. 4 shows a traditional fluid delivery system such as a fluid delivery system used for a coffee machine which comprises a mixing device (sometimes considered as a brewing device), a heating device and a pump. The mixing device and the heating device are separately arranged. The pump is connected to the heating device and mixing device via tubes and is used to pump hot water from the heating device to the mixing device which contains coffee powder to thereby make coffee.

However, the traditional fluid delivery system uses a lot of tubes which cause a loss in the efficiency of the pump. Furthermore, the traditional fluid delivery system occupies a large space.

Therefore, there is a need for an improved fluid delivery system which can solve the above-mentioned problems.

### SUMMARY OF THE INVENTION

Accordingly, the present invention provides a fluid delivery system comprising: a mixing chamber for mixing a liquid and a substance contained therein, the mixing chamber having at least two inlets for entering of the liquid and the substance and an outlet for the discharge of the liquid and substance; a pump connected to one of the inlets and outlet for urging the liquid to enter into the mixing chamber via one of the inlets and exit the mixing chamber via the outlet; and a heating/cooling device associated with the mixing chamber and arranged to heat/cool the liquid and substance contained in the mixing chamber.

Preferably, the pump is connected to said one of the inlets and outlet directly.

Preferably, the heating device is disposed within the mixing chamber.

Alternatively, the mixing chamber is disposed within the heating device.

Preferably, the mixing chamber comprises a mixing structure for mixing the liquid and substance.

Preferably, the mixing chamber comprises a plurality of curved portions which function as the mixing structure.

Preferably, the mixing chamber is arranged to receive a plurality of liquids and each liquid has a respective inlet to the mixing chamber.

Preferably, the mixing chamber is arranged to receive a plurality of substances and each substance has a respective inlet to the mixing chamber.

Preferably, the fluid delivery system is a fluid delivery system of a beverage maker such as a coffee machine or tea machine, or a cleaning apparatus such as a carpet cleaner, a dish washer or a washing machine.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a fluid delivery system in accordance with a first embodiment of the present invention;

FIG. 2 illustrates a fluid delivery system in accordance with a second embodiment of the present invention;

FIG. 3 illustrates a fluid delivery system in accordance with a third embodiment of the present invention; and

FIG. 4 illustrates a traditional fluid delivery system.

### DETAILED DESCRIPTION OF THE PREFERRED EMBODIMENTS

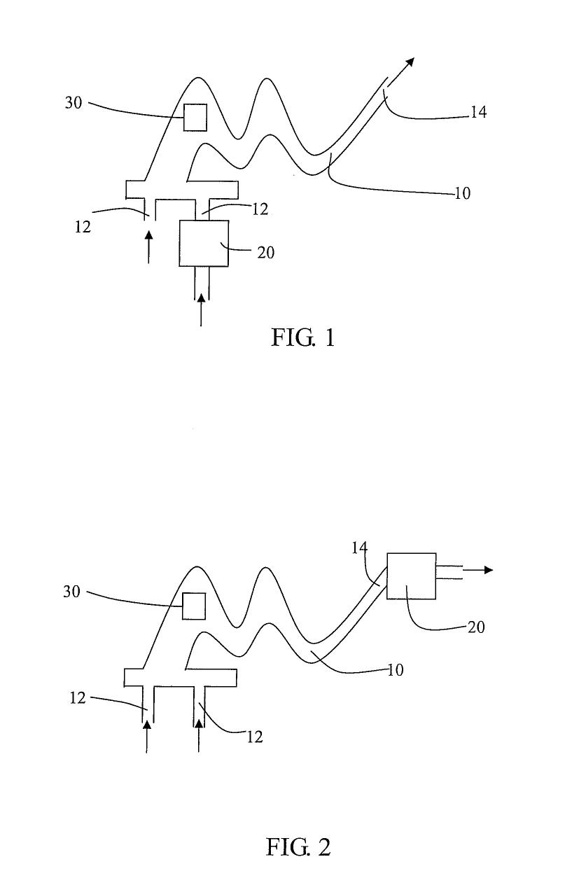

FIG. 1 illustrates a fluid delivery system in accordance with a first embodiment of the present invention. The fluid delivery system comprises a mixing chamber 10, a pump 20 and a heating and/or cooling device 30. The fluid delivery system may be used for a beverage making machine such as a coffee machine, or a cleaning appliance such as a dish washer, washing machine, carpet cleaner and so on. Usually the heating/cooling device 30 will be just a heating device. However, in some embodiments, the device may be only a cooling device or may be able to be selected to operate as a heater or as a cooler, for example in a beverage machine able to make hot or cold tea or coffee.

The mixing chamber 10 has a plurality of inlets 12 and at least one outlet 14. The number of inlets 12 can be adjusted according to demand. Substances are added to the mixing chamber 10 via the inlets 12. For example, when the fluid delivery system is used for a coffee machine, coffee powder and/or sugar may be added into the mixing chamber 10 via one of the inlets 12 and water may be added into the mixing chamber 10 via another inlet 12. When the fluid delivery system is used for a carpet cleaner, cleaning detergent may be added into the mixing chamber 10 via one of the inlets 12 and water may be added into the mixing chamber 10 via another inlet 12.

Preferably, the mixing chamber 10 comprises a mixing structure for facilitating mixing the liquid and substances entering from the inlets 12. For example, the mixing chamber 10 has a pipe configuration with several curved portions formed between the inlets 12 and outlet 14 of the pipe configuration. The curved portions function as the mixing structure.

Alternatively, a mixing structure such as a stirrer may be installed within the mixing chamber 10.

The pump 20 is connected to one of the inlets 12 of the mixing chamber 10. Preferably, the pump 20 is connected to the inlet 12 directly without additional tubes connected between the inlet 12 and the pump 20 in order to reduce the frictional losses in the fluid flow path.

Alternatively, the pump 20 may be connected to the outlet 14 directly, as shown in FIG. 2.

Preferably, the heating/cooling device 30 is connected to the mixing chamber 10 as a separate device. Preferably, the heating device 30 is installed within the mixing chamber 10 such that the heating device 30 can heat the substance contained in the chamber 10 directly. A temperature sensor may be provided in the mixing chamber 10, to control the temperature of the device 30 when used as a heater or as a cooler.

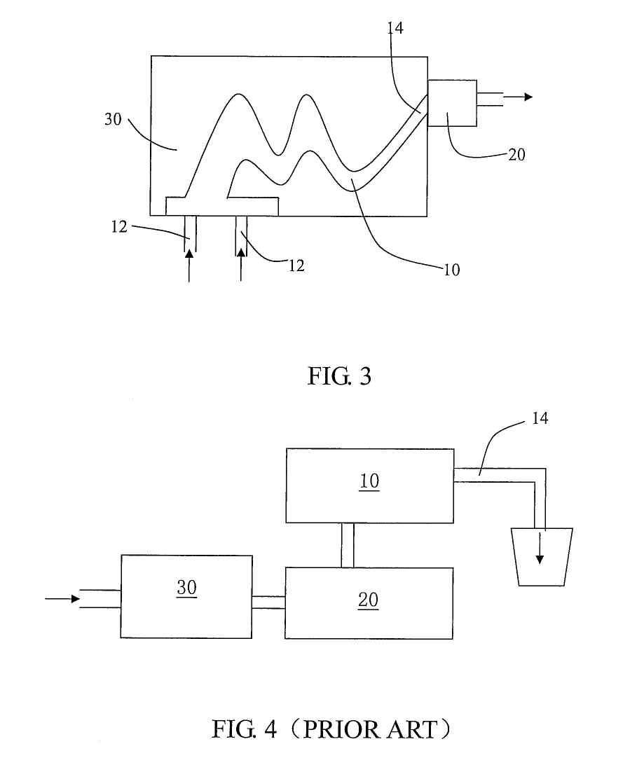

Alternatively, if the size of the heating/cooling device 30 is large enough the mixing chamber 10 may be formed in the device 30, as shown in FIG. 3.

As mentioned, the heating/cooling device 30 may be a simple heating device or a simple cooling device 30. For some applications the heating/cooling device 30 may be arranged to be selectively operable to heat or cool the substance contained in the mixing chamber 10.

In the present invention, the heating/cooling device 30 is integrally connected to the mixing chamber 10, which results in a compact fluid delivery system.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A fluid delivery system comprising:
a mixing chamber for mixing a liquid and a substance contained therein, the mixing chamber having at least two inlets for entering of the liquid and the substance and an outlet for the discharge of the liquid and substance;
a pump connected to one of the inlets and outlet for urging the liquid to enter into the mixing chamber via one of the inlets and exit the mixing chamber via the outlet; and
a heating/cooling device associated with the mixing chamber and arranged to heat/cool the liquid and substance contained in the mixing chamber.

2. The system of claim 1, wherein the pump is connected to said one of the inlets and outlet directly.

3. The system of claim 1, wherein the heating device is disposed within the mixing chamber.

4. The system of claim 1, wherein the mixing chamber is disposed within the heating device.

5. The system of claim 1, wherein the mixing chamber comprises a mixing structure for mixing the liquid and substance.

6. The system of claim 5, wherein the mixing chamber comprises a plurality of curved portions which function as the mixing structure.

7. The system of claim 1, wherein the mixing chamber is arranged to receive a plurality of liquids and each liquid has a respective inlet to the mixing chamber.

8. The system of claim 1, wherein the mixing chamber is arranged to receive a plurality of substances and each substance has a respective inlet to the mixing chamber.

9. The system of claim 1, wherein the fluid delivery system is a fluid delivery system of a beverage maker.

10. The system of claim 1, wherein the fluid delivery system is a fluid delivery system of a cleaning appliance.
